(19) United States
(12) Patent Application Publication
(10) Pub. No.: US 2011/0148907 A1
(43) Pub. Date: Jun. 23, 2011

(54) Method and system for image display with uniformity compensation

(76) Inventor: Bongsun Lee, Cupertino, CA (US)

(21) Appl. No.: 12/655,098

(22) Filed: Dec. 23, 2009

(51) Int. Cl. G09G 5/02

(52) U.S. Cl. 345/590

(57) ABSTRACT

A method and system are provided for image display with color transformations that also compensate for non-uniformities in different regions of a display. The method involves performing color measurements at different locations or zones of a display, and deriving respective compensation factors based on these measurements and corresponding target color values, such as those associated with a reference display. These zone- or location-specific compensation factors can be used to derive appropriate compensation factors for arbitrary pixels in an image, which are then used for color transformation of the pixels for display.

### TECHNICAL FIELD

This invention relates to a method and a system for image display with uniformity compensation.

### BACKGROUND

Displays, such as flat-panel displays, need to be calibrated or characterized so that colors in an image reproduced on a display are an accurate representation of the colors originally intended for the image. The image with colors as originally intended by a creator of the image is often referred to as a reference look. A display needs to be calibrated or characterized so that the image on the display will resemble as closely as possible the reference look.

A calibration system for a display generally measures the characteristics of the display and calibrates the display to produce target values such as primary color gamut, gamma, color temperature, and so on, as consistent with the reference look. In one example, an external calibration tool with a sensor device is used to measure the characteristics of a display at the center of the display screen. Such a system is often used in the field, but its performance is limited to the characteristics of the displays. If a display has uniformity issues across its screen, e.g., variations in display characteristics such as chromaticity, lightness and chroma, among others, a characterization performed at the center of the screen may not provide satisfactory results for displaying images on the entire screen.

### BRIEF SUMMARY OF THE INVENTION

Embodiments of the present invention relate to a method and system for compensating for non-uniformity of display characteristics in a display.

One embodiment provides a method for use in image display, which includes: (a) providing a number of zones on a display; (b) providing color parameters for each zone; and (c) providing a set of compensation factors for each zone based on the color parameters.

Another embodiment provides a system for use in image display, which includes a memory for providing at least two sets of compensation factors, each set being associated with one of at least two zones on a display, and at least one processor configured for deriving compensation factors for an input pixel, the compensation factors for the input pixel being derived from at least one of the two sets of compensation factors associated with the at least two zones on the display.

Yet another embodiment provides a system, which includes a sensor for performing color measurements at a plurality of zones in a screen, a first processor for deriving a plurality of sets of compensation factors for the plurality of zones based on the color measurements, a memory for storing the derived plurality of sets of compensation factors, and at least a second processor for computing compensation factors for use in transforming colors of a pixel of an image based on at least some of the plurality of sets of compensation factors for the zones.

### BRIEF DESCRIPTION OF THE DRAWING

The teachings of the present invention can be readily understood by considering the following detailed description in conjunction with the accompanying drawings, in which:

FIG. 1 is a schematic illustration of a system suitable for characterizing a display according to the present principles;

FIG. 2 is a schematic illustration of a display screen divided into different zones for characterization according to one embodiment of the present principles;

FIG. 3 is a schematic illustration of an arbitrary pixel and other pixels in the display of FIG. 2;

FIG. 4 is a schematic illustration of a system in accordance with one embodiment of the present principles; and

FIG. 5 illustrates one method according to the present principles.

To facilitate understanding, identical reference numerals have been used, where possible, to designate identical elements that are common to the figures.

### DETAILED DESCRIPTION

Embodiments of the present invention provide a method and system for image display with color transformation that also compensates for display non-uniformities that may exist in different regions of a display (or spatial variation of the display characteristics).

In one embodiment, a display is calibrated or characterized by first dividing the display into a number of zones. A sensor is used to measure one or more display characteristics at a location of each zone, e.g., at the center pixel of each zone. Based on the measured color values, compensation factors are computed for the measurement location such as the center pixel of each zone. These compensation factors are representative of the differences between the characteristics of the display and those of a reference look, e.g., characteristics or colors as originally intended or as displayed on a reference display. Based on these “location-specific” or “zone-specific” compensation factors (i.e., each factor being associated with a particular measurement location within a zone), additional compensation factors for an arbitrary pixel (i.e., at any location of the display) can be obtained by interpolation using the location-specific compensation factors. The resulting factors for the arbitrary pixel can be used to compute or derive the Red, Green and Blue (RGB) color values that can be used to reproduce the target or reference look at that pixel. Since the zone-specific compensation factors are used to derive the RGB values for any pixel in an image for display, any non-uniformities in the display characteristics in different regions of the display can be compensated for.

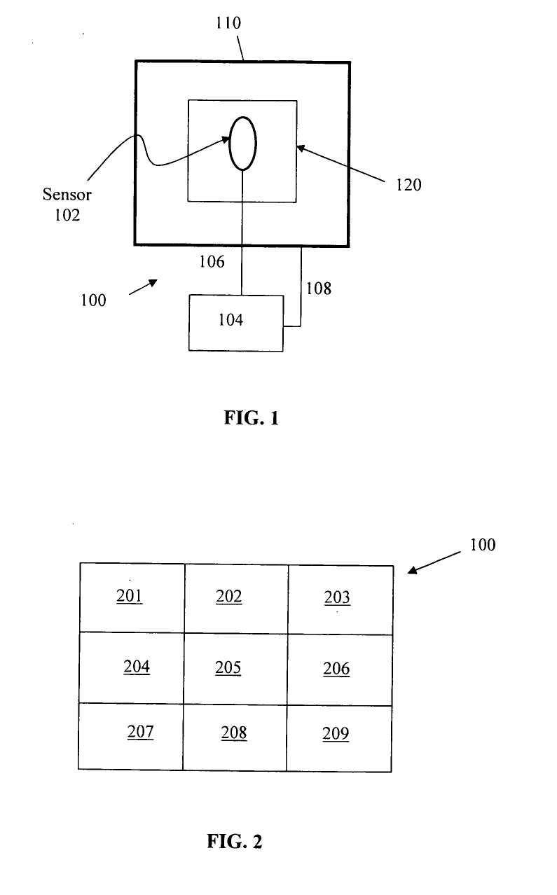

FIG. 1 shows a display or screen 110 connected to a characterization system 100, which can be used to obtain compensation factors for non-uniformity compensation of the display. The display 110 may be, for example, a flat-panel display such as a liquid crystal display (LCD), plasma or liquid crystal on silicon (LCoS) display. In the illustrated embodiment, the characterization system 100 includes a measurement sensor 102, and a processor 104 (which may be provided as a part of a computer). The measurement sensor 102, which is connected to the processor 104 via a communication channel 106 (e.g., a universal serial bus (USB) or RS-232C, among others) is used to measure the tristimulus values (e.g., CIE XYZ) or spectral power of color patches on any area or portion of the display 110.

A color patch is provided for each zone, e.g., each patch may be the same size as each zone, or may be smaller than the zone (patch projected on the screen occupies only a portion of the zone). These measurements can be done in different manners, e.g., using a white patch or different patches for the primary colors, R, G and B. If a measurement is done on a white patch, the same compensation factor (to be discussed later) derived from the measurement can be applied to all channels, i.e., to R, G, B, of each pixel. Since grey represents a reduced intensity of white, one can also use a grey patch having an intensity less than 100% of white. However, a dark grey patch is generally not suitable because of the difficulty in distinguishing between intensity variations. Thus, in one embodiment, a grey patch having an intensity of greater than about 70% and less than 100% of white is used.

Alternatively, separate measurements can be done using different color patches of R, G, B, respectively (e.g., maximum R, G, B), at a central location of a zone. Compensation factor for each color (or channel) can then be computed from the measurements, and applied to each color for each pixel accordingly.

One example of a sensor suitable for use in the present invention is a spectroradiometer, e.g., Model PR-705 from Photo Research, of Chatsworth, Calif., USA.

A video interface 108, e.g., Digital Visual Interface (DVI) or High-Definition Multimedia Interface (HDMI), may be used for interfacing the processor 104 to the display 110. Software installed on the system contains instructions, which, when executed by the processor 104, would divide the display 110 into a number of zones as shown in FIG. 2. In the illustrated example, the display 110 is divided into nine zones. However, different number of zones may be used in other embodiments, depending on the desired accuracy of the characterization. Although it may be desirable to provide the zones in a regular or symmetrical configuration (e.g., each zone having the same area and/or shapes), it is also possible to have one or more zones with different shapes and/or dimensions compared to others. For many displays, non-uniformity tends to be worse towards the corners or sides of the display compared to the center portion. Thus, in another embodiment, the display may be provided with a larger number of measurement zones in certain areas of the display, e.g., where non-uniformity is expected or known to be worse. Thus, the measurement zones can be non-uniformly distributed within the area of the display device.

The software instructions would also direct the measurement sensor 102 to perform measurements of spectral power or tristimulus values at a location within each zone on the display 110. If spectral power is measured, e.g., as a function of wavelength in a range of 400-700 nm, then the CIEXYZ tristimulus values will be computed from the spectral power data. Although only one patch (corresponding to one zone) is shown in FIG. 1 for clarity's sake, it is understood that, according to embodiments of the present principles, measurements are to be performed in at least two different zones, each with at least one patch. The processor 104 also drives the display 110 (e.g., through the video interface 108) to show a white patch 120 for each zone (e.g., maximum value 255 for an 8-bit display system) on the display 110.

Data obtained from the measurements are device-independent values of a color, which correspond to the amounts of three primary colors in a 3-component additive color model needed to match the specific color. In one example, the data are given by the tristimulus values XYZ (as used in the CIE XYZ color space defined by the International Commission on Illumination), which specify colors as perceived in human vision, independent of the display devices. These XYZ values are the device-independent color values that correspond to the device-dependent values (e.g., RGB) of the patch 120 (i.e., the RGB values associated with or used to describe the color of the patch). In alternative embodiments, other color spaces (i.e., different from CIE XYZ) can also be used.

Furthermore, measurements can be performed using the system 100 to obtain a 3×3 matrix, which is often used to transform color values from RGB to XYZ. As will be discussed below, this 3×3 matrix can be used to convert the RGB values of any pixel of an input image to the device-independent XYZ values, which can in turn be used to derive chromaticity and brightness parameters corresponding to the input pixel. By performing measurements on separate maximum R, G, B patches, e.g., maximum R is (255,0,0), maximum G is (0,255,0), maximum B is (0,0,255), three corresponding device-independent XYZ values can be obtained for each patch. Specifically, the XYZ values for maximum R constitute elements in the first column of the matrix, the XYZ values for maximum G constitute elements in the second column, and the XYZ values for maximum B constitute elements in the third column.

From XYZ values, the chromaticity parameters (x,y) and luminance or brightness parameter (Y) can be obtained from the respective expressions in Eq. 1:

x=X/(X+Y+Z) Eq. 1(a)

y=Y/(X+Y+Z) Eq. 1(b)

Y=Y Eq. 1(c)

By measuring X, Y and Z values at the center of each of the nine patches, nine sets of (x, y, Y) values can be calculated, with each set corresponding to one zone, respectively. The values obtained from the measurements are denoted by (xᵢ^{m}, yᵢ^{m}, Yᵢ^{m}), where i=1 to 9. The larger the differences among the various measured values, the larger is the non-uniformity within the display 100. If desired, X, Y and Z values can also be measured at other selected locations within a patch, and not necessarily at the center.

According to the present principles, target values for the display are set to match those of a reference display, e.g., one that is used in post-production. In one example, the values of (x, y, Y) are set to x=0.3127, y=0.3290, and Y=30 fL, where fL stands for foot lambert. These are referred to as target values (xᵢ^{t}, yᵢ^{t}, Yᵢ^{t}, where i=1 to 9).

Compensation factors (CF) for x, y and Y can then be calculated for the center of each zone using the following expressions in Eq. (2).

CFₓ=xᵢ^{t}/xᵢ^{m} Eq. 2(a)

CF_{y}=yᵢ^{t}/yᵢ^{m} Eq. 2(b)

CF_{Y}=Yᵢ^{t}/Yᵢ^{m} Eq. 2(c)

where i=1 to 9

These compensation factors are representative of the difference between the measured (xᵢ^{m}, yᵢ^{m}, Yᵢ^{m}) and the target (xᵢ^{t}, yᵢ^{t}, Yᵢ^{t}) values (the target values being representative of the reference look), and can be used to derive additional compensation factors for any arbitrary pixels in the display. By providing compensation factors associated with different zones on the display, color parameters for image pixels at different locations of the display can be compensated for any display non-uniformities that may exist in different zones. Note that these compensation factors apply only for the center pixel (or the measured pixel) of each zone. For an arbitrary pixel (at any location), the compensation factor is obtained by interpolating the compensation factors of two or more neighborhood or surrounding center pixels, as explained below.

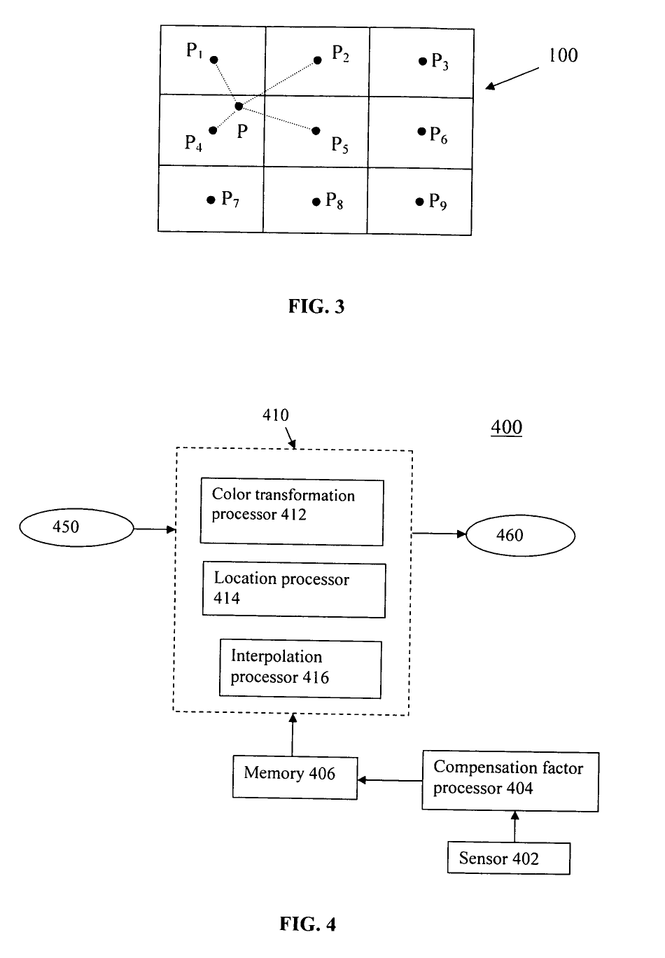

FIG. 3 shows an example of a spatial relationship between an arbitrary pixel P (e.g., any pixel P in an input image to be displayed) and other “center” pixels from the various zones of the display 100. In this case, the compensation factors for pixel P are calculated from the compensation factors of the four closest neighboring pixels (P₁, P₂, P₄ and P₅). In other embodiments, compensation factors from additional center pixels that are farther away (e.g., one or more pixels such as P₃, P₆-P₉ from other zones) may also be included in calculating the compensation factor for pixel P. However, their contributions are expected to be less significant than those of the closest pixels P₁, P₂, P₄ and P₅.

Eq. 3 gives the expressions relating the compensation factors for pixel P to the compensation factors of pixels P₁, P₂, P₄, P₅ and their corresponding weighting factors (w1, w2, w4, w5).

CFₓ_{_{P}}=(w₁×CFₓ_{₁}+w₂×CFₓ_{₂}+w₄×CFₓ_{₄}+w₅×CFₓ_{₅})/(w₁+w₂+w₄+w₅)

CF_{y}_{_{P}}=(w₁×CF_{y}_{₁}+w₂×CF_{y}_{₂}+w₄×CF_{y}_{₄}+w₅×CF_{y}_{₅})/(w₁+w₂+w₄+w₅)

CF_{Y}_{_{P}}=(w₁×CF_{Y}_{₁}+w₂×CF_{Y}_{₂}+w₄×CF_{Y}_{₄}+w₅×CF_{Y}_{₅})/(w₁+w₂+w₄+w₅) Eq. 3

where CFₓ_{_{P}}, CF_{y}_{_{P}}, and CF_{Y}_{_{P}}, are the respective compensation factors for x, y and Y for the pixel P; and CFₓ_{ᵢ}, CF_{y}_{ᵢ}, and CF_{Y}_{ᵢ} are the compensation factors for x, y and Y for surrounding pixels Pᵢ in respective zones i (where i=1, 2, 4 and 5).

In this discussion, the relationships in Eq. (3) for obtaining the set of compensation factors for pixel P (i.e., CFₓ_{_{P}}, CF_{y}_{_{P}}, and CF_{Y}_{ₚ}) are also referred to as interpolations or weighted sums using the other compensation factors and the weighting factors.

The weighting factors wᵢ are related to the distance between pixel P and each of the corresponding pixels P₁, P₂, P₄ and P₅. Specifically, the smaller the distance between P and a given center pixel, the larger the weighting factor for that center pixel. Thus, in the example of FIG. 3, if the distances between P and the neighboring pixels are represented by d₁, d₂, d₄ and d₅, and if d₄<d₁<d₅<d₂, then the relationship among the weighting factors will be w₄>w₁>w₅>w₂.

In other words, the weighting factor for each neighborhood pixel is inversely proportional to the distance between the neighborhood pixel and the arbitrary pixel P. This can be expressed as: w₁=k/d₁; w₂=k/d₂; w₄=k/d₄ and w₅=k/d₅, where k is a proportionality constant, e.g., can be any number. In one embodiment, k is equal to 1.

Once the compensation factors for the pixel P are computed (may be referred to as a second set of compensation factors, or “pixel-specific” factors, to distinguish from the first set of compensator factors associated with the measured pixel in each zone), they can be used to generate color values or parameters suitable for use in displaying pixel P of an image. For example, these compensation factors can be multiplied to the chromaticity and luminance values (x_{P}, y_{P}, Y_{P}) at the pixel P of an image to be displayed to produce target values at the pixel P, as shown in the expressions for Eq. (4) below:

x_{P}^{t}=CFₓ_{_{P}}(x_{P}); Eq. 4(a)

y_{P}^{t}=CF_{y}_{_{P}}(yₚ); Eq. 4(b)

Y_{P}^{t}=CF_{y}_{_{P}}(Y_{P}) Eq. 4(c)

Note that these (x_{P}, y_{P}, Y_{P}) values for the pixel P of an image can be calculated using at least the 3×3 matrix previously discussed, i.e., the matrix obtained by measuring maximum R, G, and B patches. Specifically, (x_{P}, y_{P}, Y_{P}) can be calculated by transforming the RGB values of pixel P of the image into XYZ values using the 3×3 matrix, and then applying Eq. (1).

To display the pixel P of the image on a suitable device, the target (x_{P}^{t}, y_{P}^{t}, Y_{P}^{t}) values of the pixel P (obtained from Eq. 4 above) are converted to device-independent target XYZ values, e.g., using expressions in Eq. (1), and then to target RGB values, e.g., using an inverse of the 3×3 matrix.

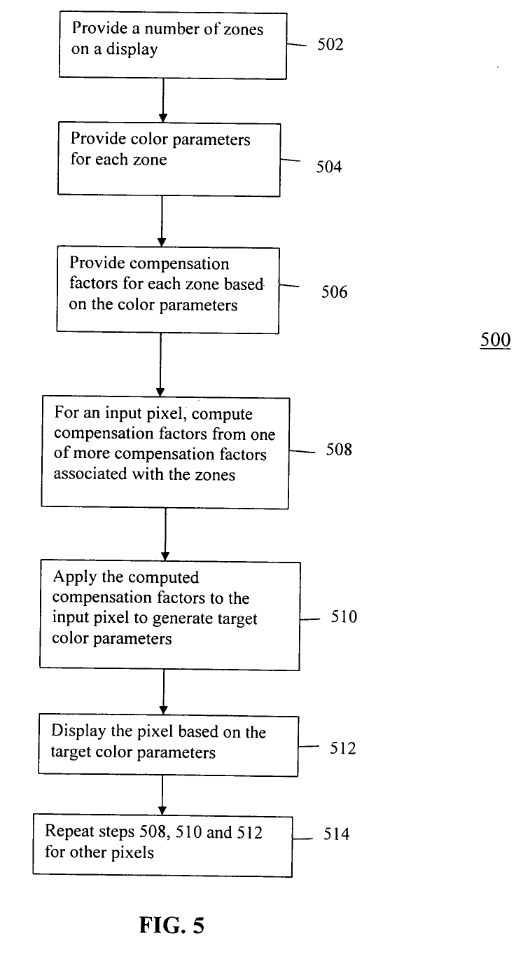

FIG. 4 is a schematic diagram showing a display compensation system 400 suitable for use in compensating for display non-uniformity. In this example, system 400 includes a measurement sensor 402, one or more processors (e.g., 404, 412, 414 and 416), and a memory 406, and can be implemented in a set-top box or inside a display device. In other embodiments, one or more processors or memories may be provided as components that are separate from the system 400 (but can be coupled to, or provided to work in conjunction with system 400). The sensor 402, which is similar to sensor 102 previously discussed, is used for measuring XYZ values at a selected or predetermined location, e.g., the center point, of each zone on the screen or display. The compensation factor processor 404 computes the compensation factors using Eq. (1) and (2) and stores them in the system memory 406.

When an input video signal 450 arrives at the uniformity compensation unit 410, it is first processed by a color transformation processor 412. Here, the input RGB values for each pixel are transformed to XYZ values using a 3×3 matrix that is characteristic of the display, and the XYZ values are converted to xyY values using Eq. (1). The 3×3 matrix can be obtained from measurements of maximum R, G and B patches, as previously explained. Note that other methods of transforming from RGB to XYZ values (aside from using the 3×3 matrix) can also be used conjunction with the non-uniformity compensation method of this invention.

The location processor 414 finds neighborhood pixel(s) of the input pixel based on the location of the input pixel, and computes weighting factors using the distance between the input pixel and each neighboring pixel, as previously discussed. The number of neighborhood pixels to be used may be determined in accordance with a rule or criterion available to the system 400.

The interpolation processor 416 calculates the compensation factors (i.e., CFₓ_{_{P}}, CF_{y}_{_{P}}, and CF_{Y}_{_{P}}) for the xyY values of the input pixel P using Eq. (3), and multiplies these factors with the respective x, y, and Y values of the input pixel provided by processor 412. The resulting xyY values (e.g., target xyY values from Eq. 4) are transformed to XYZ using the inverse of Eq. (1), and then transformed to RGB values, e.g., using the inverse matrix of the original 3×3 transformation matrix. These transformations are performed by the processor 412, resulting in an output signal 460 corresponding to the input RGB pixel, which is compensated to achieve target values.

Thus, by using different compensation factors for different pixels on the display, a display device can display an image according to the reference look and also compensates for non-uniformity in display characteristics throughout the entire screen.

FIG. 5 illustrates one embodiment of a method 500 to compensate for spatial non-uniformities in color display characteristics of a display device. In step 502, a number of zones (at least two) are provided for the display.

In step 504, one or more color parameters are provided for each zone. For example, the color parameters may be a set of parameters that include chromaticity parameters (x, y) and luminance parameter Y, or the tristimulus values XYZ as known in the CIE XYZ color space. The parameters x, y and Y for each zone are obtained from the XYZ values measured at a location for a color patch, e.g., a white patch provided in each zone. As mentioned above, instead of a white patch, a grey patch or separate color patches such as R, G, B patches may also be used for such measurements. Furthermore, different color spaces (other than CIE XYZ) can also be used. In one embodiment, the measurement location is at or near the center pixel of each zone.

In step 506, compensation factors are obtained for each zone based on the set of color parameters. For example, a set of compensation factors can be computed by taking a ratio of target x, y and Y values of a reference display to the respective x, y, and Y values of the display (from step 504), e.g., using Eq. (2), and can, optionally, be stored in memory. These compensation factors may be referred to as “zone-specific” factors.

Steps 502, 504 and 506 may be considered as a part of a calibration procedure for the display.

In step 508, for a given input pixel (i.e., pixel in an input video image), a set of compensation factors, e.g., x, y and Y, are derived from one or more of the compensation factors provided in step 506 for the various zones. For example, if the input pixel coincides with a location at which color parameters are available (see step 504), e.g., by measurement of one or more color patches, then the compensation factors for the input pixel would be equal to the compensation factors from step 506, e.g., based on the color patch measurements. Otherwise, the compensation factor for the input pixel would be derived from two or more compensation factors associated with the zones, which may be done by interpolation or weighted sums, e.g., with proper weights assigned to respective compensation factors from neighborhood pixels in different zones, as previously discussed in connection with FIG. 3.

In step 510, the compensation or color correction factors calculated in step 508 are applied to the input pixel, e.g., by multiplying each of the compensation factors to a corresponding color value or parameter for the input pixel.

For example, the color values or parameters for the input pixel may be chromaticity and luminance values (xyY) derived from the tristimulus XYZ values, which are obtained by transforming the RGB values of the input pixel using a 3×3 matrix. By applying the color correction or compensation factors, the xyY values of the input pixel are transformed into target xyY values, e.g., values corresponding to a reference display (e.g., for producing a desired look such as that of a reference look). The relationship for the compensation factors, the xyY values of the input pixel and the target xyY values is previously discussed and shown in Eq. 4 (a), (b) and (c).

In step 512, the target xyY values may be used for displaying the input pixel, e.g., by first transforming them into tristimulus values XYZ and then to RGB values suitable for use in image display.

As shown in step 514, the procedures in steps 508 through step 512 are repeated for additional pixels of an input video image signal, and the resulting RGB values from the color transformation are used for displaying at least a portion of the image. Alternatively, steps 508 and 510 may be repeated for a number of pixels (optionally, with computed compensation factors and/or target color parameters for the pixels stored in memory), prior to the display of the pixels based on respective target color parameters.

In other embodiments, one or more steps in FIG. 5 may be omitted, or be performed in different orders or combinations. For example, steps 502, 504 and 506 may be performed prior to the display of an image, and compensation factors for each zone can be stored in memory for later use. In such a case, a method for image display may start with a step similar to step 508, which computes compensation factors for a pixel based on the compensation factors provided for the zones, e.g., by interpolation or weighted sums. The computed compensation factors can then be applied to the pixel to generate target color parameters suitable for use in displaying the pixel, similar to step 510. The computation and generation of target color parameters can be performed for all pixels of an image prior to displaying the image.

While the forgoing is directed to various embodiments of the present invention, other and further embodiments of the invention may be devised without departing from the basic scope thereof. As such, the appropriate scope of the invention is to be determined according to the claims, which follow.

What is claimed is:

1. A method for use in image display, comprising:
(a) providing a number of zones on a first display;
(b) providing color parameters for each zone; and
(c) providing a set of compensation factors for each zone based on the color parameters.

2. The method of claim 1, wherein the color parameters for each zone are derived from a color measurement on at least one color patch within each zone.

3. The method of claim 2, wherein the color parameters includes chromaticity and luminance values.

4. The method of claim 2, wherein the color measurement produces device-independent tristimulus values for the at least one color patch.

5. The method of claim 2, wherein the at least one color patch is a white patch.

6. The method of claim 2, wherein the at least one color patch includes separate red, green and blue patches.

7. The method of claim 2, wherein the color measurement is performed at a center location for each zone.

8. The method of claim 1, wherein each compensation factor is a function of one of the color parameters for the display and a corresponding color parameter for a reference display.

9. The method of claim 1, further comprising:
(d) deriving compensation factors for an input pixel from compensation factors associated with at least one zone; and
(e) applying the derived compensation factors to the input pixel.

10. The method of claim 9, wherein the compensation factors are derived in step (d) by performing interpolation of the compensation factors associated with at least two zones.

11. The method of claim 9, wherein step (e) comprises multiplying each of the derived compensation factors to a corresponding color parameter of the input pixel to produce a transformed color parameter.

12. A system for use in image display, comprising:
a memory for providing at least two sets of compensation factors, each set being associated with one of at least two zones on a display; and
at least one processor configured for deriving compensation factors for an input pixel, the compensation factors for the input pixel being derived from at least one of the two sets of compensation factors associated with the at least two zones on the display.

13. The system of claim 12, wherein the at least one processor is configured to derive the compensation factors for the input pixel by weighted sums using the at least two sets of compensation factors associated with the zones on the display and weighting factors that are functions of distances between the input pixel and the at least two zones.

14. The system of claim 13, wherein the at least one processor is further configured for applying the derived compensation factors to the input pixel for transforming colors of the input pixel for display.

15. The system of claim 12, further comprising:
a sensor for measuring at least two sets of color parameters, each of the sets of color parameters being associated with one of the at least two zones on the display; and
the at least one processor further configured for generating the at least two sets of compensation factors for the at least two zones from the measured sets of color parameters.

16. The system of claim 15, wherein the color parameters include device-independent tristimulus values.

17. The system of claim 12, wherein the system is a set-top box.

18. The system of claim 12, wherein the memory and the at least one processor are integrated into the display.

19. A system, comprising:
a sensor for performing color measurements at a plurality of zones in a screen;
a first processor for deriving a plurality of sets of compensation factors for the plurality of zones based on the color measurements;
a memory for storing the derived plurality of sets of compensation factors; and
at least a second processor for computing compensation factors for use in transforming colors of a pixel of an image based on at least some of the plurality of sets of compensation factors for the zones.
